(19) United States
(12) Patent Application Publication
(10) Pub. No.: US 2017/0340907 A1
(43) Pub. Date: Nov. 30, 2017

(54) OXYGEN GENERATION APPARATUS

(71) Applicant: CoolerBIT Technology Ltd., Taipei City (TW)

(72) Inventor: Jian-Dih Jeng, Taipei City (TW)

(21) Appl. No.: 15/163,317

(22) Filed: May 24, 2016

(51) Int. Cl. A62B 21/00; C01B 13/02

(52) U.S. Cl. CPC A62B 21/00; C01B 13/0296

(57) ABSTRACT

An oxygen generation apparatus of the first embodiment includes an outer container, a container lid, a piercing member, and an inner container. An annular flange is formed inside the inner container, and a surface of the annular flange is provided with two sealing films to accommodate an oxygen generating agent. The piercing member may move from a first position to a second position relative to the container lid, so as to break the sealing films to mix the oxygen generating agents to generate oxygen; an oxygen generation apparatus of the second embodiment includes two inner containers, where an annular flange is formed on one inner container to dispose a sealing film to accommodate an oxygen generating agent, a bottom surface of another inner container is provided in a concave manner with an accommodation space which accommodates the piercing member.

### BACKGROUND

### Technical Field

The present invention relates to an oxygen generation apparatus.

### Related Art

The demand of a human body for oxygen is self-evident. The sufficient oxygen supply helps relieve stress and sober up the brains. In addition to the demands of health care, in aspects of medical treatment and first aid, for example, when first aid is performed on an asthma patient or when a fire accident occurs in an entertainment site, a carry-on oxygen generation apparatus is more needed to prevent loss of lives and property.

It is well-known that the oxygen generation apparatus includes the following types: (1) a pressurized oxygen cylinder, where oxygen is fed into a cylinder in a high pressure manner by using a compressor for storage, and when oxygen is needed, the oxygen cylinder is used in cooperation with a respirator to supply oxygen for a user to use; (2) an air-separation-type oxygen generation apparatus, where compressed air is filtered by using a molecular sieve to separate the oxygen; and (3) a chemical-reaction-type oxygen generation apparatus, where a chemical action is performed on an oxygen generating agent by using a catalyst in the apparatus, and accelerated decomposition is performed on oxygen molecules in the oxygen generating agent to supply oxygen.

However, the foregoing oxygen generation apparatuses all have disadvantages. An oxygen cylinder is heavy, and it is difficult to store the oxygen cylinder, when oxygen is supplemented, the oxygen must be supplemented at a specific site; and a compressor of the oxygen cylinder needs to use a power supply to pressurize the oxygen, so the entire apparatus is complex. An air-separation-type apparatus is costly and needs to use a power supply to filter air, a volume of the apparatus is huge, the apparatus can only be deployed at a specific site, and the apparatus needs to be maintained as scheduled. If a chemical-reaction-type apparatus uses sodium borate as an oxygen generating agent, a heat source is needed to perform decomposition on sodium borate.

In view of the above, the greatest disadvantages of known oxygen generation apparatuses is that it is difficult to carry them for use; and in an emergency where oxygen medical treatment is needed, it is impossible to use the oxygen generation apparatus to supply oxygen immediately. Further, for a chemical-reaction-type apparatus, after an oxygen generating agent stops generating oxygen, an oxygen generating agent needs to be supplemented by oneself. However, it is difficult to store and carry an oxygen generating agent.

### SUMMARY

In view of this, the present invention proposes an oxygen generation apparatus.

In a first embodiment, the oxygen generation apparatus includes an outer container, a container lid, a piercing member, and an inner container. The container lid is provided with a hole, and the container lid may be locked in a spinning manner to an opening end of the outer container; a first end of the piercing member is movably combined with the container lid to enable the piercing member to move to a first position and a second position relative the container lid, and a second end of the piercing member has a saw-toothed structure. The inner container is disposed inside the outer container and configured to accommodate an oxygen generating agent, an annular flange is formed inside the inner container, an upper surface of the annular flange is provided with a first sealing film, and a lower surface of the annular flange is provided with a second sealing film. When the piercing member is located at the first position, the saw-toothed structure is at a distance from the first sealing film, and when the piercing member is located at the second position, the saw-toothed structure penetrates through the first sealing film and the second sealing film.

In the first embodiment, the foregoing inner container further includes an outer wall, an inner wall, and a connection wall, the inner wall defines an opening of the inner container, the outer wall surrounds the inner wall and is connected to the inner wall through the connection wall, the inner wall extends from the opening toward a bottom surface of the outer container, a distance between an end edge of the inner wall and the bottom surface is greater than a distance between an end edge of the outer wall and the bottom surface, the outer wall defines another opening of the inner container, the annular flange is disposed in a convex manner on the inner wall, the end edge of the outer wall is provided with a third sealing film, and when the piercing member is located at the second position, the saw-toothed structure further penetrates through the third sealing film.

In the first embodiment, an inner wall of the foregoing outer container is provided in a convex manner with a plurality of bumps, and a surface of each of the bumps stops the outer wall of the inner container, so as to enable the third sealing film and the bottom surface of the outer container to form an accommodation space.

In the first embodiment, the outer wall of the foregoing inner container is further provided in a concave manner with at least one positioning recess, which extends along a direction vertical to a circumferential direction of the foregoing outer wall, the inner wall of the outer container is further provided in a convex manner with another bump, the another bump is embedded into each positioning recess to position the inner container in the outer container.

In the first embodiment, the inner wall of the outer container is further provided in a convex manner with a first stopping block and a second stopping block inside the foregoing accommodation space, a vertical distance from the first stopping block to the bottom surface of the outer container is not equal to a vertical distance from the second stopping block to the bottom surface of the outer container, the oxygen generation apparatus further includes a filter screen, and the filter screen is stopped between the first stopping block and the second stopping block.

In the first embodiment, another inner container is further included and disposed inside the outer container, the another inner container is configured to accommodate the foregoing inner container, an inner wall of the another inner container is provided in a convex manner with a plurality of bumps, a surface of each of the bumps stops the outer wall of the inner container, so as to enable the third sealing film and a bottom surface of the another inner container to form another accommodation space, and the reactant is disposed in the foregoing another accommodation space.

In the first embodiment, the outer wall of the foregoing inner container is further provided in a concave manner with at least one positioning recess, which extends along a direction vertical to a circumferential direction of the foregoing outer wall, the inner wall of the another inner container is further provided in a convex manner with another bump configured to be embedded into each recess to position the foregoing inner container in the another inner container.

In the first embodiment, a bottom of the outer container further includes a plurality of limiting flanges disposed at intervals, an outer surface of the foregoing another inner container is provided in a convex manner with a limiting convex column corresponding to the limiting flanges, and the limiting convex column moves between two adjacent limiting flanges.

In the first embodiment, the inner wall of the another inner container is further provided in a convex manner with a first stopping block and a second stopping block inside the foregoing another accommodation space, a vertical distance from the first stopping block to the bottom surface of the another inner container is not equal to a vertical distance from the second stopping block to the bottom surface of the another inner container, the oxygen generation apparatus further includes a filter screen, and the filter screen is stopped between the first stopping block and the second stopping block.

In the first embodiment, the piercing member further includes at least one notch, located at a second end of the piercing member, and when the piercing member is located at the second position, an extending line of the upper surface of the annular flange and an extending line of the at least one surface of the plurality of bumps penetrate through the at least one notch.

In the first embodiment, the container lid includes an extending foot, connected to a bottom plate of the container lid, the extending foot extends from the bottom plate toward the inner container, and when the container lid is locked in a spinning manner to the bottom, the extending foot abuts against the connection wall to position the inner container.

In the first embodiment, the container lid includes a bottom plate and a surrounding wall, an end of the surrounding wall is connected to a surface of a side, facing the inner container, of the bottom plate, the surrounding wall surrounds the hole, the piercing member has an opening on the first end, the piercing member is combined with the surrounding wall through the opening in a surrounding manner, so as to be able to move to the first position and the second position relative to the surrounding wall.

In the first embodiment, an outer surface of the surrounding wall includes a groove, a first bearing rib, and a second bearing rib, the groove includes a vertical groove section and a horizontal groove section, the vertical groove section extends along a direction vertical to the outer surface of the surrounding wall, the horizontal groove section extends along a circumferential direction of the outer surface of the surrounding wall, the first bearing rib and the second bearing rib are respectively disposed in a convex manner on the vertical groove section and the horizontal groove section, the first end of the piercing member is provided with an elastic plate, a terminal end of the elastic plate is provided in a convex manner with a flange corresponding to the first bearing rib and the second bearing rib, the flange may move in the vertical groove section and the horizontal groove section, the first bearing rib is configured to stop the flange to position the piercing member at the first position, and the second bearing rib is configured to stop the flange to position the piercing member at the second position.

In the first embodiment, the second bearing rib extends along an extending direction of the vertical groove section, the flange is provided in a concave manner with a vertical recess, and the second bearing rib may be clamped inside the vertical recess to stop the flange.

In a second embodiment, the oxygen generation apparatus includes an outer container, a container lid, a piercing member, a first inner container, and a second inner container. The container lid is provided with a hole, and the container lid may be locked in a spinning manner to an opening end of the outer container; a first end of the piercing member is connected to the container lid, and a second end of the piercing member has a saw-toothed structure; a first inner container is configured to accommodate an oxygen generating agent and disposed inside the outer container, the first inner container has an opening and a bottom surface opposite to the opening, and the bottom surface is disposed in a concave manner toward the opening to form an accommodation space; the second inner container is configured to accommodate another oxygen generating agent and disposed inside the first inner container to seal the opening, an annular flange is formed inside the second inner container, an upper surface of the annular flange is provided with a first sealing film, and a lower surface of the annular flange is provided with a second sealing film, where when the bottom surface of the first inner container is disposed inside the outer container in a manner of facing the container lid, and the container lid is locked in a spinning manner to the bottom, the piercing member is accommodated inside the accommodation space, and when the bottom surface of the first inner container is disposed in the outer container in a manner of facing the bottom surface of the outer container, and the container lid is locked in a spinning manner to the bottom, the saw-toothed structure penetrates the first sealing film and the second sealing film.

In the second embodiment, the second inner container further includes an outer wall, an inner wall, and a connection wall, the inner wall defines an opening of the second inner container, the outer wall surrounds the inner wall and is connected to the inner wall through the connection wall, the inner wall extends from the opening of the second inner container toward the bottom surface of the first outer container, a distance between an end edge of the inner wall and the bottom surface is greater than a distance between an end edge of the outer wall and the bottom surface, the outer wall defines another opening of the second inner container, the annular flange is disposed in a convex manner on the inner wall, the end edge of the outer wall is provided with a third sealing film, and when the bottom surface of the first inner container is disposed inside the outer container in a manner of facing the bottom surface of the outer container, and the container lid is locked in a spinning manner to the bottom, the saw-toothed structure further penetrates through the third sealing film.

In the second embodiment, an inner wall of the first inner container is provided in a convex manner with a plurality of bumps, and a surface of each of the bumps stops the outer wall of the second inner container.

In the second embodiment, the outer wall of the foregoing second inner container is further provided in a concave manner with at least one positioning recess, which extends along a direction vertical to a circumferential direction of the foregoing outer wall, the inner wall of the first inner container is further provided in a convex manner with another bump, the another bump is embedded into each positioning recess to position the second inner container in the first inner container.

In the second embodiment, the piercing member further includes at least one notch, located at a second end of the piercing member, and when the bottom surface of the first inner container is disposed inside the outer container in a manner of facing the bottom surface of the outer container, and the container lid is locked in a spinning manner to the bottom, an extending line of the upper surface of the annular flange and extending lines of surfaces of the plurality of bumps penetrate through the foregoing notch.

In the second embodiment, a bottom of the outer container further includes a plurality of limiting flanges disposed at intervals, an outer surface of the foregoing first inner container is provided in a convex manner with a limiting convex column corresponding to the limiting flanges, and the limiting convex column moves between two adjacent limiting flanges.

In the second embodiment, the container lid includes an extending foot, connected to a bottom plate of the container lid, the extending foot extends from the foregoing bottom plate toward the second inner container, and when the bottom surface of the first inner container is disposed inside the outer container in a manner of facing the bottom surface of the outer container, and the container lid is locked in a spinning manner to the bottom, the extending foot abuts against the connection wall to position the second inner container.

In the second embodiment, when the piercing member is accommodated inside the accommodation space, the foregoing extending foot abuts against the bottom surface of the first inner container to position the first inner container.

In the second embodiment, the inner wall of the first inner container is further provided in a convex manner with a first stopping block and a second stopping block between the third sealing film and the bottom surface of the first inner container, a vertical distance from the first stopping block to the bottom surface of the first inner container is not equal to a vertical distance from the second stopping block to the bottom surface of the first inner container, the oxygen generation apparatus further includes a filter screen, and the filter screen is stopped between the first stopping block and the second stopping block.

In conclusion, according to the first embodiment and second embodiment of the oxygen generation apparatus of the present invention, in addition to an advantage of portability with respect to the prior art, an accommodation space is formed between an outer wall and an inner wall of an inner container, and when a chemical reaction is performed on an oxygen generating agent, if the reaction is violent, a great amount of gas is generated, and part of the gas may be temporarily accommodated between the outer wall and the inner wall, which would not cause a problem that a great amount of gas mixed with the oxygen generating agent is sputtered out through a hole. Further, with respect to a product that does not have the foregoing accommodation space, an outer diameter of an opening of an inner container may be designed to be smaller to further reduce an outer diameter of a sealing film, so as to make it easier to scratch the sealing film.

### BRIEF DESCRIPTION OF THE DRAWINGS

The present invention will become more fully understood from the detailed description given herein below for illustration only, and thus are not limitative of the present invention, and wherein:

FIG. 1 is a schematic diagram of an embodiment of an oxygen generation apparatus according to the present invention;

FIG. 2 is a schematic breakdown diagram (I) of a first embodiment of the oxygen generation apparatus of FIG. 1;

FIG. 3 is a schematic breakdown diagram (II) of the first embodiment of the oxygen generation apparatus of FIG. 1;

FIG. 4 is a sectional diagram of a piercing member located at a first position in the first embodiment of the oxygen generation apparatus of FIG. 1;

FIG. 5 is a sectional diagram of the piercing member located at a second position in the first embodiment of the oxygen generation apparatus of FIG. 1;

FIG. 6 is a sectional diagram of an implementation manner of the first embodiment of the oxygen generation apparatus of FIG. 1;

FIG. 7 is a schematic enlarged diagram of the piercing member in the first embodiment of the oxygen generation apparatus of FIG. 1;

FIG. 8 is a sectional diagram (I) of a second embodiment of the oxygen generation apparatus of FIG. 1; and

FIG. 9 is a sectional diagram (II) of the second embodiment of the oxygen generation apparatus of FIG. 1.

### DETAILED DESCRIPTION

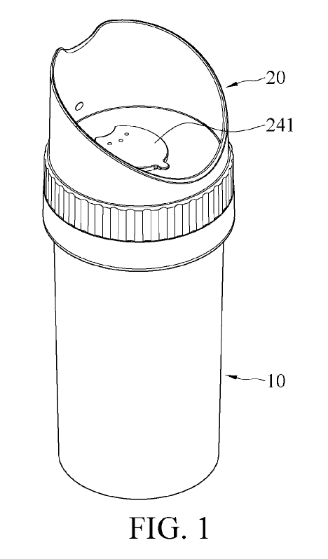

Referring to FIG. 1, FIG. 1 is a schematic diagram of an embodiment of an oxygen generation apparatus according to the present invention and discloses an oxygen generation apparatus, inside of which an oxygen generating agent may be accommodated, the oxygen generating agent includes a reactant, a reaction liquid, and a catalyst, and after the foregoing three are mixed and are subject to a chemical reaction, oxygen can be generated.

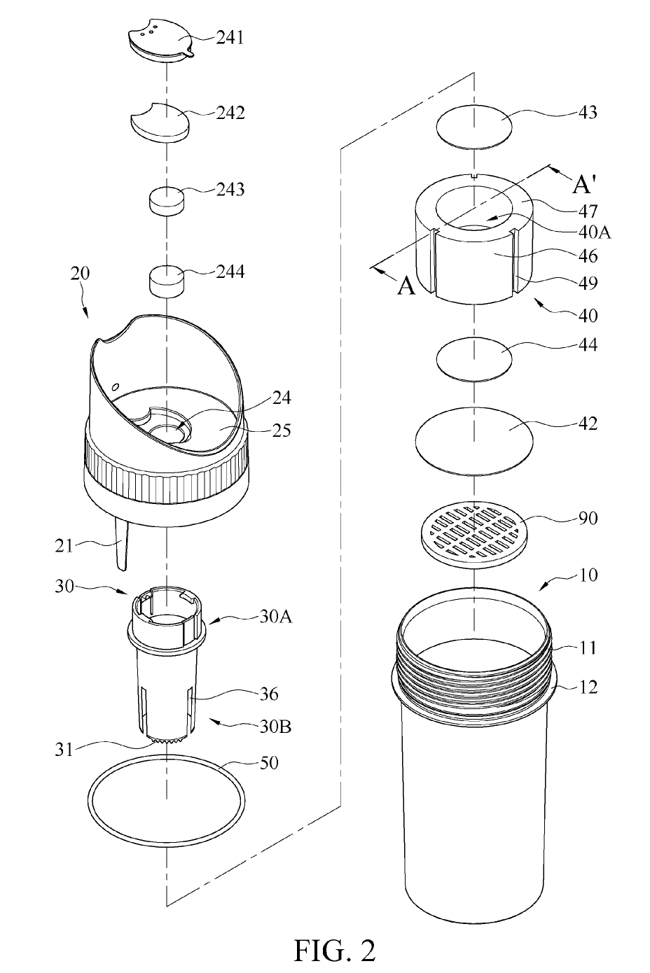

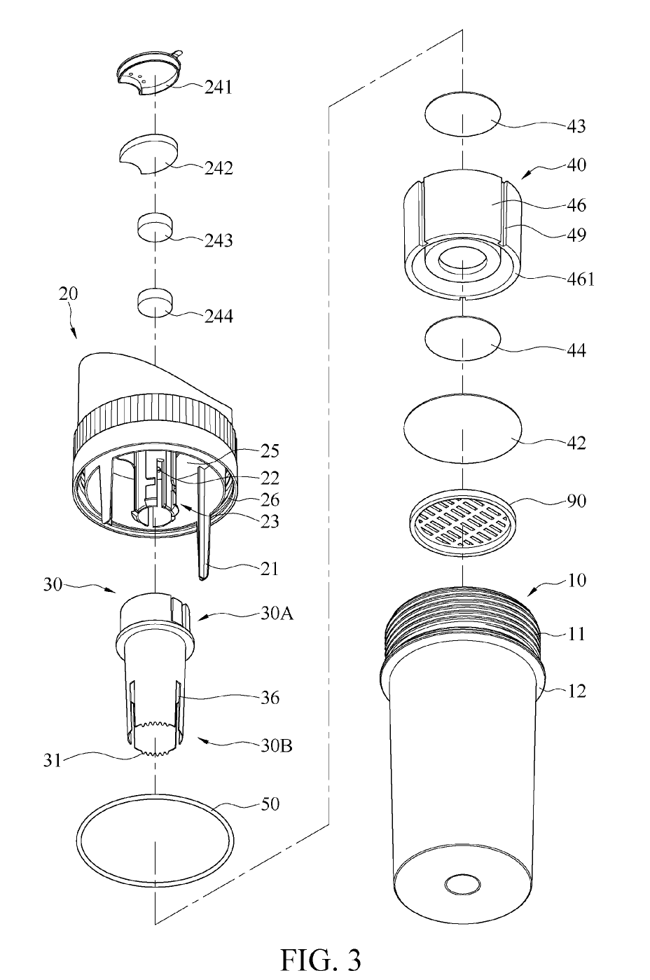

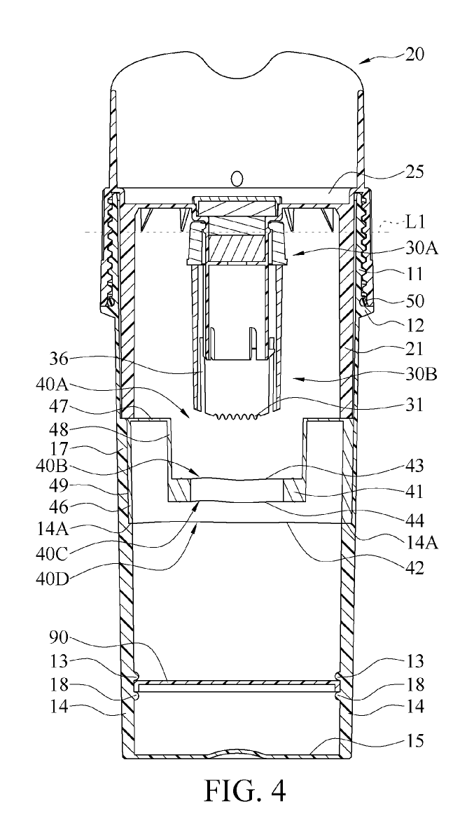

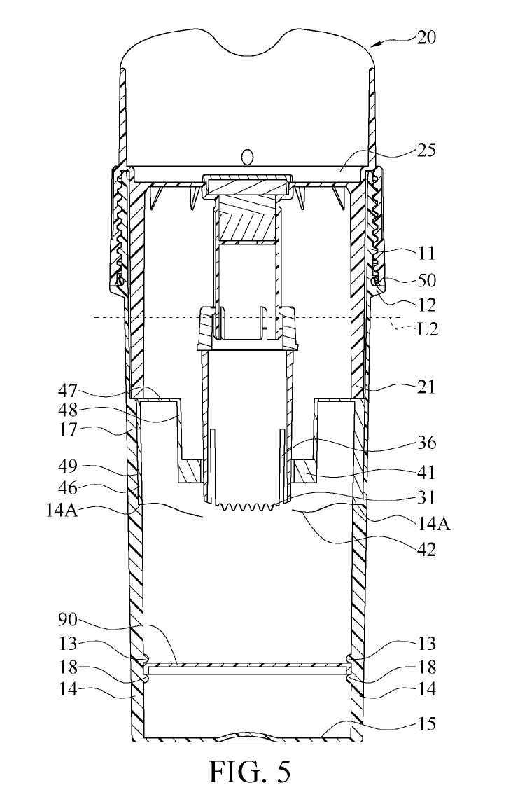

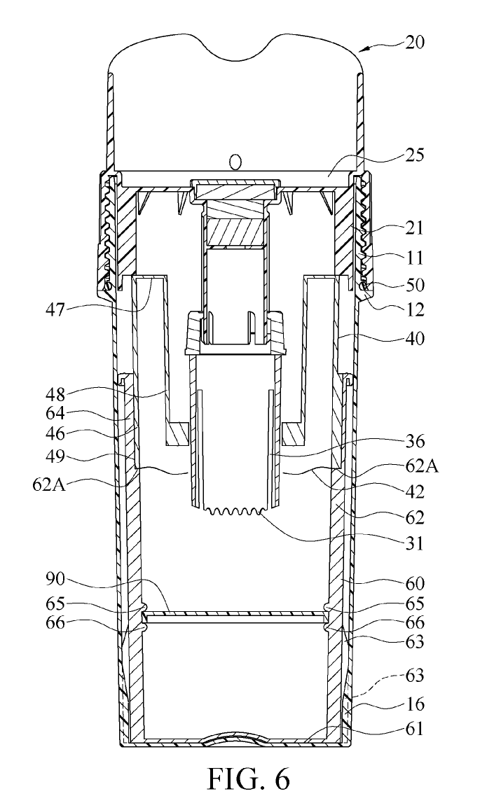

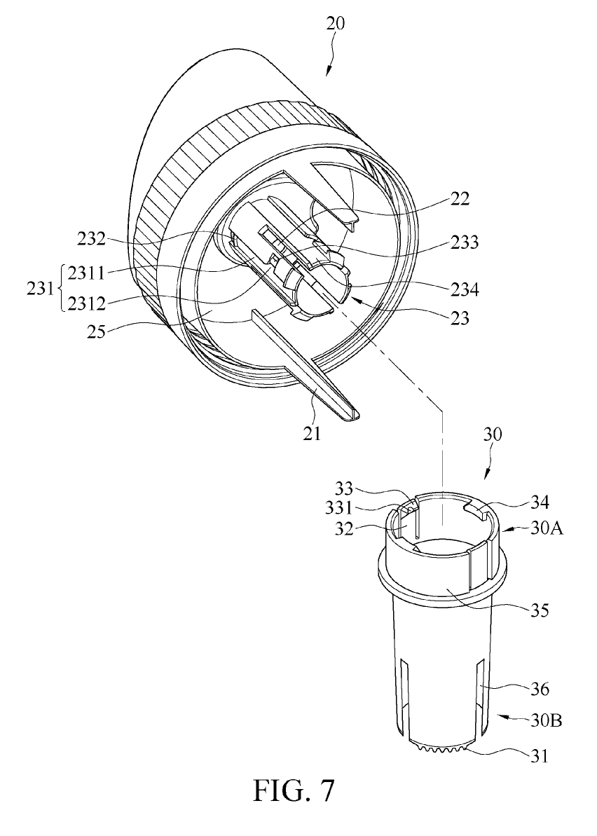

Referring to FIG. 2 to FIG. 7 at the same time, FIG. 2 and FIG. 3 are respectively a schematic breakdown diagram (I) and a schematic breakdown diagram (I) of a first embodiment of the oxygen generation apparatus of FIG. 1. FIG. 4 and FIG. 5 are respectively sectional diagrams along a section line A-A′ of the oxygen generation apparatus of FIG. 2. FIG. 6 is a sectional diagram of another implementation manner of the first embodiment of the oxygen generation apparatus of FIG. 1. FIG. 7 is a schematic enlarged diagram of the piercing member in the first embodiment of the oxygen generation apparatus of FIG. 1.

As shown in FIG. 2 and FIG. 3, the oxygen generation apparatus mainly includes an outer container 10, a container lid 20, a piercing member 30, and an inner container 40. Components are separately further described in the following.

An inner side surface of the container lid 20 is provided with an inner screw thread 26, and an outer edge of an opening end of the outer container 10 is provided with an outer screw thread 11 matching the inner screw thread 26. Hence, the inner screw thread 26 is connected in a screwed manner to the outer screw thread 11 to enable the container lid 20 to be locked in a spinning manner to the opening end of the outer container 10, so as to seal an opening of the outer container 10. In addition, a bottom plate 25 of the container lid 20 is provided with a hole 22 for oxygen to diffuse.

The inner container 40 is disposed inside the outer container 10 and configured to accommodate an oxygen generating agent. As shown in FIG. 4, the inner container 40 includes an outer wall 46, an inner wall 48, and a connection wall 47. The outer wall 46 surrounds the inner wall 48, and the outer wall 46 is connected to the inner wall 48 through the connection wall 47, and it could be known from FIG. 4 that the outer wall 46 and the inner wall 48 are spaced by a distance to form an accommodation space. The inner wall 48 defines an opening 40A of the inner container 40, the inner wall 48 extends from the opening 40A toward a bottom surface 15 of the outer container 10, and a straight-line distance from an end edge of the inner wall 48 to the bottom surface 15 is greater than a straight-line distance from an end edge of the outer wall 46 to the bottom surface 15. In this way, the outer wall 46 defines an opening 40D of the inner container 40. Further, as shown in FIG. 4, an annular flange 41 is formed inside the inner container 40 and disposed in a convex manner on the inner wall 48. An opening 40B is defined on an upper surface of the annular flange 41, and an opening 40C is defined on a lower surface of the annular flange 41.

Hence, the inner container 40 may be stuffed with the oxygen generating agent through the two openings 40A, 40D. An example of stuffing the inner container 40 with the catalyst and the reaction liquid is used as an example in the following, and the catalyst and the reaction liquid may be respectively stuffed between the upper surface and lower surface of the annular flange 41 and inside the accommodation space formed from the inner wall 48 and outer wall 46. Hence, the upper surface of the annular flange 41 is provided with a first sealing film 43, the lower surface of the annular flange 41 is provided with a second sealing film 44, the end edge of the outer wall 46 is provided with a third sealing film 42, and the first sealing film 43, the second sealing film 44, and the third sealing film 42 respectively seal the openings 40B, 40C, and 40D, so as to prevent the catalyst and reaction liquid from leaving the inner container 40.

In some implementation manners, as shown in FIG. 4 and FIG. 5, the inner wall of the outer container 10 is provided in a convex manner with a plurality of bumps (referred to as first bumps 14 for convenience of description), configured to stop the inner container 40. That is, the outer wall 46 of the inner container 40 may abut against surfaces 14A of the first bumps 14, so that the inner container 40 is stopped on the surfaces 14A and accommodated inside the outer container 10. In this way, the reactant may be stuffed inside the accommodation space between the third sealing film 42 and the bottom surface 15 of the outer container 10, and when the outer wall 46 of the inner container 40 abuts against each of the first bumps 14, the third sealing film 42 seals the opening of the outer container 10, so that the reactant does not leave the outer container 10.

In some other implementation manners, as shown in FIG. 6, the oxygen generation apparatus may further include another inner container 60 disposed inside the outer container 10, the inner container 60 is configured to accommodate the inner container 40, and an inner wall of the inner container 60 is provided in a convex manner with a plurality of bumps (hereinafter referred to as first bumps 62 for convenience of description), configured to stop the inner container 40. That is, the outer wall 46 of the inner container 40 may abut against surfaces 62A of the first bumps 62, so that the inner container 40 is stopped on the surfaces 62A and accommodated inside the inner container 10. In this case, the reactant may be stuffed in the accommodation space between the third sealing film 42 and a bottom surface 61 of the inner container 60 without leaving the inner container 60.

A first end 30A of the piercing member 30 is combined with the container lid 20, and the piercing member 30 can move to a first position L1 and a second position L2 relative the container lid 20; a second end 30B of the piercing member 30 has a saw-toothed structure 31; on the basis of this, as shown in FIG. 4, when the piercing member 30 is located at the first position L1, even if the container lid 20 is locked in a spinning manner along the outer screw thread 11 to the bottom (namely, a stopping flange 12), the saw-toothed structure 31 is distal from the inner container 40 and is spaced from the first sealing film 43 by a distance, and at this time, the saw-toothed structure 31 does not penetrate through the first sealing film 43; in another aspect, as shown in FIG. 5, when the piercing member 30 is located at the second position L2, and the container lid 20 is locked in a spinning manner to the bottom, the saw-toothed structure 31 penetrates through the first sealing film 43, the second sealing film 44, and the third sealing film 42, so that the reactant, the reaction liquid, and the catalyst may be mixed to generate oxygen.

In some implementation manners, a stuffing position of the reaction liquid, reactant, and catalyst may also be adjusted according to requirements, which is not limited in the present invention. Moreover, the catalyst may be manganous sulfate (MnSO₂), enzyme, or manganese dioxide (MnO₂), so as to increase a rate of generating oxygen by the reaction liquid or reactant. Further, the reaction liquid may be water, saline water, or another aqueous solution.

On the basis of this, when the reaction liquid, the reactant, and the catalyst are subject to a chemical reaction, if the reaction is violent, a great amount of gas is generated, and part of the gas may be temporarily accommodated in the accommodation space between the outer wall 46 and the inner wall 48, which would not cause a problem that a great amount of gas mixed with the oxygen generating agent is sputtered out through the hole 22. Further, with respect to a product that does not have the foregoing accommodation space, an outer diameter of the opening 40A of the inner container 40 may be designed to be smaller to further reduce an outer diameter of the sealing films 43, 44, so as to make it easier for the saw-toothed structure 31 to scratch the sealing films 43, 44.

In some implementation manners, as shown in FIG. 4 to FIG. 6, the container lid 20 has an extending foot 21, the extending foot 21 is connected to the bottom plate 25 of the container lid 20, and the extending foot 21 extends from the bottom plate 25 toward the inner container 40. On the basis of this, in the implementation manner shown in FIG. 4, when the container lid 20 is locked in a spinning manner along the outer screw thread 11 to the stopping flange 12, the extending foot 21 abuts against the connection wall 47 to position the inner container 40 in the outer container 10, so as to prevent the inner container 40 from rotating relative to the outer container 10 because of being subject to an external force or prevent the saw-toothed structure 31 from breaking the three sealing films 42, 43, 44 of the inner container 40 when a user inverts the oxygen generation apparatus. In the implementation manner shown in FIG. 6, when the piercing member 30 is located at the first position L1 and the container lid 20 is locked in a spinning manner along the outer screw thread 11 to the stopping flange 12, the extending foot 21 abuts against the connection wall 47 to position the inner container 40 in the outer container 60, so as to prevent the inner container 40 from rotating relative to the outer container 60 because of being subject to an external force or prevent the saw-toothed structure 31 from breaking the three sealing films 42, 43, 44 of the inner container 40 when a user inverts the oxygen generation apparatus.

Referring to FIG. 7, the container lid 20 further includes a surrounding wall 23, and the surrounding wall 23 is disposed on a side, facing the inner container 40, of the bottom plate 25 and configured to be combined with the piercing member 30. The surrounding wall 23 extends from the bottom plate 25 toward the inner container 40, and an outer surface of the surrounding wall 23 includes a groove 231. Two grooves 231 are used as an example in this embodiment, but the present invention is not limited thereto, and there may be one groove or even three or more grooves. The groove 231 includes a vertical groove section 2311 and a horizontal groove section 2312, the vertical groove section 2311 extends along a direction vertical to the surface of the surrounding wall 23, and the horizontal groove section 2312 extends along a circumferential direction of the surface of the surrounding wall 23. The groove 231 is provided with two bearing ribs (referred to as a first bearing rib 232 and a second bearing rib 233 for convenience of description) and the first bearing rib 232 and the second bearing rib 233 are respectively disposed in a convex manner on the vertical groove section 2311 and the horizontal groove section 2312. In this embodiment, the groove 231 presents an L shape.

The piercing member 30 is combined with the container lid 20 through the opening of the first end 30A thereof in a manner of surrounding the surrounding wall 23. The first end 30A of the piercing member 3 includes an elastic plate 32 and a tube wall 35, the elastic plate 32 is spaced from its neighboring tube wall 35 by a distance and may elastically return, and a terminal end of the elastic plate 32 is provided in a convex manner with a flange 33 corresponding to the first bearing rib 232 and the second bearing rib 233. In this embodiment, a number and a shape of the elastic plates 32 correspond to the groove 231 of the surrounding wall 23, and the two elastic plate 32 are symmetrically disposed face to face, but the present invention is not limited thereto, and the two elastic plate 32 may be disposed in a staggered manner.

The first bearing rib 232 and second bearing rib 233 of the container lid 20 are configured to stop the flange 33 of the piercing member 30, and the elastic plate 32 may move relative to the surrounding wall 23 to elastically return; hence, a user may make the flange 33 and the first bearing rib 232 abut against each other face to face to enable the first bearing rib 232 to stop the flange 33, so as to fix the piercing member 30; subsequently, the user may apply a force to the piercing member 30 in a vertical direction, the elastic plate 32 departs from the surrounding wall 23 because the flange 33 abuts against the first bearing rib 232, and if the user continues applying the force in the vertical direction, the elastic plate 32 elastically returns subsequently, so as to enable the flange 33 to leave the first bearing rib 232 to move in the vertical groove section 231 of the groove 231; when the annular flange 33 enters the horizontal groove section 2312, the user may rotate the piercing member 30 in a horizontal direction, and the elastic plate 32 departs from the surrounding wall 23 because the flange 33 abuts against the second bearing rib 233; and if the user continuously applies a force in the horizontal direction, the second bearing rib 233 stops the flange 33 in the horizontal groove section 2312.

In this embodiment, the first bearing rib 232 presents a horizontal direction, the flange 33 is stopped by the first bearing rib 23 in the vertical direction, so as to fix the piercing member 30 to the first position L1; the second bearing rib 233 presents a vertical direction, the flange 33 includes a vertical recess 331 matching the second bearing rib 233, and the vertical recess 331 and the second bearing rib 233 may be clamped to each other to make the piercing member 30 fixedly located at the second position L2.

On the basis of this, when the piercing member 30 is located at the second position L2, the user of the oxygen generation apparatus may rotate the piercing member 30 along the direction of the horizontal groove section 2312 to make the vertical recess 331 be not clamped to the second bearing rib 233, so as to enable the flange 33 to leave the second bearing rib 233; the user further applies a force to the piercing member 30 along the direction of the vertical groove section 2311 to make the flange 33 move along the vertical groove section 2311 and stop in the first bearing rib 232; and in this way, the piercing member 30 moves from the second position L2 to the first position L1.

In some implementation manners, as shown in FIG. 7, the tube wall 35 of the piercing member 30 further includes two flanges 34, and the outer surface of the surrounding wall 23 further includes two grooves 234 that do not have a bearing rib; the flanges 34 match the grooves 234 in a one-to-one manner, and the flanges 34 may move inside the grooves 234, to further make the piercing member 30 combined with the surrounding wall 23 more stably. In this embodiment, an example of respectively matching the two flanges 34 with the two grooves 234 is used as an example, but the present invention is not limited thereto. According to an inner diameter size of the surrounding wall 23, a number of the flanges 34 or grooves 234 may also be one or even three or more.

In some implementation manners, the piercing member 30 includes a plurality of notches 36 located at the second end 30B of the piercing member 30. As shown in FIG. 2, FIG. 3, and FIG. 7, the piercing member 30 includes four notches 36, but the present invention is not limited thereto, and a number of notches 36 may be increased or reduced according to actual requirements. On the basis of this, when the container lid piercing member 30 is located at the second position L2, an extending line of an upper surface of the annular flange 41 and extending lines of the surfaces 62A of the first bumps 62 pass through the notches 36, so as to increases paths for the reaction liquid and the catalyst to flow into the accommodation space that accommodates the reactant.

Referring to FIG. 2 to FIG. 5 again, the container lid 20 also includes an accommodation groove 24, the accommodation groove 24 is disposed in a concave manner on the bottom plate 25 of the container lid 20, the surrounding wall 23 surrounds the accommodation groove 24, and from a view of a side, facing the inner container 40, of the bottom plate 25, the accommodation groove 24 protrudes from the bottom plate 25 toward the inner container 40, and the 22 is located on a bottom surface of the accommodation groove 24. The accommodation groove 24 accommodates a fragrant sheet 242, a waterproof air-permeable film 243, and a sponge 244 to cover the hole 22; the waterproof air-permeable film 243 is configured to filter the generated oxygen to remove a liquid other than the oxygen, the fragrant sheet 242 is configured to add a scent to oxygen to enable the user to known a start and an end of generation of oxygen, and the sponge 244 is configured to prevent the oxygen generating agent from overflowing from the oxygen generation apparatus because oxygen generation is excessively violent. In addition, the accommodation groove 24 is provided with an accommodation groove lid 241 to cover the opening of the accommodation groove 24, the fragrant sheet 242 is accommodated inside the accommodation groove, and the user may replace the fragrant sheet 242 according to a preference thereof. On the basis of this, the generated oxygen diffuses through a diffusion path formed from the opening of the piercing member 30, the opening of the surrounding wall 23, the hole 22, the sponge 244, the waterproof air-permeable film 243, and the fragrant sheet 242.

On the basis of this, when the user wants to put away the oxygen generation apparatus, the flange 33 of the piercing member 30 may be clamped to the first bearing rib 232 to prevent the saw-toothed structure 31 from piercing the sealing film 43, 44, 42 to generate oxygen; when the user wants to use the oxygen generation apparatus to generate oxygen, the container lid 20 may be opened, a distance between the saw-toothed structure 31 and the first sealing film 43 may be changed by adjusting a position of the flange 33 of the piercing member 30 in the groove 231, and after the flange 33 is stopped in the second bearing rib 233, the container lid 20 is locked in a spinning manner to actuate the saw-toothed structure 31 to pierce the sealing films 43, 44, 42 in sequence to enable the oxygen generating agent to generate oxygen.

In some implementation manners, as shown in FIG. 4 and FIG. 5, the inner wall of the outer container 10 is provided in a convex manner with another bump (hereinafter referred to a second bump 17 for convenience of description), which is in contact with the surfaces 14A of the first bumps 14, and the second bump 17 is configured to position the inner container 40. In detail, as shown in FIG. 2 and FIG. 3, the outer wall 46 of the inner container 40 is provided in a concave manner with a plurality of positioning recesses 49, and the positioning recesses 49 extend along a direction vertical to a circumferential direction of the outer wall 46 of the inner container 40. The second bump 17 may be embedded into the positioning recesses 49 in a one-to-one manner to position the inner container 40. The user may align the positioning recesses 49 with the second bump 17 and apply a force to the inner container 40 to enable the inner container 40 to move along the second bump 17 toward the bottom of the outer container 10 until a bottom surface 461 of the outer wall 46 of the inner container 40 abuts again the surfaces 14A of the first bumps 14. Hence, when the piercing member 30 rotates as the container lid 20 is subject to a force, because the inner container 40 is embedded with the first bumps 14, the inner container 40 does not rotate relative to the outer container 10, so as to further avoid that the piercing member 30 cannot pierce the sealing films 43, 44, 42.

Further, as shown in FIG. 6, the inner wall of the inner container 60 is provided in a convex manner with another bump (hereinafter referred to a second bump 64 for convenience of description), which is in contact with the surfaces 62A of the first bumps 62, and the second bump 64 is configured to position the inner container 40. The user may align the positioning recesses 49 with the second bump 64 and apply a force to the inner container 40 to enable the inner container 40 to move along the second bump 64 toward the bottom of the inner container 60 until the bottom surface 461 of the outer wall 46 of the inner container 40 abuts again the surfaces 62A of the first bumps 62. Hence, when the piercing member 30 rotates as the container lid 20 is subject to a force, because the inner container 40 is embedded with the second bump 64, the inner container 40 does not rotate relative to the inner container 60, so as to further avoid that the piercing member 30 cannot pierce the sealing films 43, 44, 42.

It should be noted that a number of the positioning recesses 49 shown in FIG. 2 being three is merely illustrative, the present invention is not limited thereto, and the number of positioning recesses 49 may also be one, two, or even four or more. Further, an end of the positioning recess 49 shown in FIG. 2 and FIG. 3 is connected to the connection wall 47, and another end of the positioning recess 49 is connected to the bottom surface 461 of the outer wall 46; however, in some other implementation manners, an end, proximal to the connection wall 47, of the positioning recess 49 may also not be connected to the connection wall 47. In addition, an end, proximal to the bottom surface 461, of the positioning recess 49 may also not be connected to the bottom surface 461; hence, in this implementation manner, the second bump 64 is not in contact with the surfaces 62A of the first bumps 62.

In some implementation manners, as shown in FIG. 6, a bottom of the outer container 10 further includes a plurality of limiting flanges 16 disposed at intervals, an outer surface of the inner container 60 is provided in a convex manner with a limiting convex column 63 corresponding to the limiting flanges 16, and the limiting convex column 63 moves between two adjacent limiting flanges 16 to prevent the inner container 60 from rotate relative to the outer container 10 as the container lid 20 rotates, so as to avoid that the piercing member 30 cannot pierce the sealing films 43, 44, 42.

On the basis of this, in the implementation manners shown in FIG. 4 and FIG. 5, the inner container 40 and the outer container 10 may be designed to be replaceable, and when the oxygen generating agent inside the inner container 40 and the outer container 10 is depleted because of oxygen generation, the user may replace by himself or herself the inner container 40 that is not broken by the piercing member 30 and the outer container 10 that is stuffed with the oxygen generating agent, so as to repeatedly use the piercing member 30 and the container lid 20 to generate oxygen. In the implementation manner shown in FIG. 6, the two inner containers 40, 60 may be designed to be replaceable, and when the oxygen generating agent inside the two inner containers 40, 60 is depleted because of oxygen generation, the user may replace by himself or herself the inner container 40 that is not broken by the piercing member 30 and the another inner container 60 that is stuffed with the oxygen generating agent, so as to repeatedly use, the outer container 10, the container lid 20, and the piercing member 30 to generate oxygen, thereby improving convenience in use.

To ensure that the oxygen generating agent in the oxygen generation apparatus would not be leaked through the container lid 20, and a waterproof gas-tight ring 50 is disposed on the stopping flange 12 of the outer container 10, so as to stuff the gap between the container lid 20 and the outer container 10, thereby improving tightness of the oxygen generation apparatus.

In some implementation manners, as shown in FIG. 2 and FIG. 3, the oxygen generation apparatus further includes a porous filter screen 90, and the filter screen 90 may be made of a porous material such as a sieve or activated carbon. The filter screen 90 is configured to remove air bubbles generated after reaction water, the reaction liquid, and the catalyst are mixed or break relatively large air bubbles into fine air bubbles, so as to prevent the large air bubbles, together with the oxygen generating agent, from diffusing from the hole 22.

In the implementation manners shown in FIG. 2 to FIG. 5, the filter screen 90 is disposed inside the outer container 10. In detail, the inner wall of the outer container 10 is further provided in a convex manner with a first stopping block 13 and a second stopping block 18 between the third sealing film 42 and the bottom surface 15, and a vertical distance from the first stopping block 13 to the bottom surface 15 is greater than (that is, not equal to) a vertical distance from the second stopping block 18 to the bottom surface 15. The filter screen 90 may be stopped between the first stopping block 13 and the second stopping block 18. Hence, the user may apply a force to the filter screen 90 in a vertical direction to enable the filter screen 90 to move in a manner of abutting against the first stopping block 13 to be sopped between the first stopping block 13 and the second stopping block 19.

In the some other implementation manners, as shown in FIG. 6, the filter screen 90 is disposed inside the inner container 60. The inner wall of the outer container 60 is further provided in a convex manner with a first stopping block 65 and a second stopping block 66 between the third sealing film 42 and the bottom surface 61, and a vertical distance from the first stopping block 65 to the bottom surface 61 is greater than (that is, not equal to) a vertical distance from the second stopping block 66 to the bottom surface 61. Hence, the filter screen 90 may be stopped between the first stopping block 65 and the second stopping block 66.

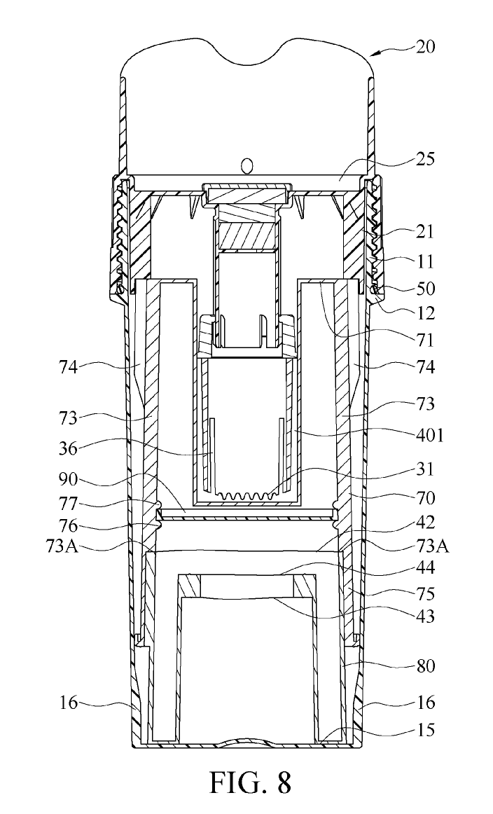

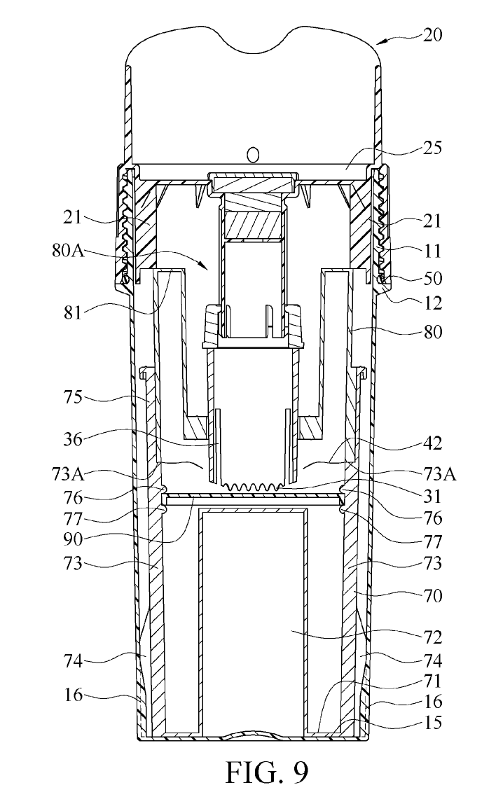

FIG. 8 is a sectional diagram (I) of a second embodiment of the oxygen generation apparatus of FIG. 1. FIG. 9 is a sectional diagram (II) of the second embodiment of the oxygen generation apparatus of FIG. 1. Referring to FIG. 8 and FIG. 9 at the same time, in the second embodiment, the oxygen generation apparatus includes a container lid 20, an outer container 10, a piercing member 30, a first inner container 70, and a second inner container 80, where the container lid 20 and the outer container 10 are approximately the same as those in the first embodiment, and the second inner container 80 is approximately the same as the inner container 40 in the first embodiment, which are not described again herein.

It should be noted that in the second embodiment, the piercing member 30 cannot move, and in the oxygen generation apparatus shown in FIG. 8 and FIG. 9, the piercing member 30 being located at the second position L2 is used as an example to describe the manner in which the piercing member 30 cannot be move, but the present invention is not limited thereto, and the piercing member 30 and the container lid 20 may be integrally shaped components as long as the piercing member 30 is located at the second position L2 relative to the surrounding wall 23.

The first inner container 70 is disposed inside the outer container 10, an inner wall of the first inner container 70 is also provided in a convex manner with a plurality of first bumps 73 and a second bump 75, and the second bump 75 is in contact with surfaces 73A of the first bump 73. Further, an outer surface of the first inner container 70 is provided in a convex manner with a limiting convex column 74 corresponding to the limiting flanges 16. The first inner container 70 has a bottom surface 71 opposite to the opening thereof, and as shown in FIG. 9, the bottom surface 71 is disposed in a concave manner toward the opening to form an accommodation space 72. In some implementation manners, respectively stuffing the catalyst and reaction liquid between the first sealing film 43 and the second sealing film 44 and between the second sealing film 44 and the third sealing film 42 is used as an example, and in this case, the reactant may be stuffed in an accommodation space between the third sealing film 42 and the bottom surface 71 of the first inner container 70. On the basis of this, the inner wall of the outer container 70 is further provided in a convex manner with a first stopping block 76 and a second stopping block 77 between the third sealing film 42 and the bottom surface 71, and a vertical distance from the first stopping block 76 to the bottom surface 71 is greater than (that is, not equal to) a vertical distance from the second stopping block 77 to the bottom surface 71. The filter screen 90 may be stopped between the first stopping block 76 and the second stopping block 77, so as to remove air bubbles generated when the oxygen generating agent is subject to a chemical reaction.

As shown in FIG. 8, the accommodation space 72 is configured to accommodate the piercing member 30, and when the user does not need the oxygen generation apparatus to generate oxygen, the bottom surface 71 of the first inner container 70 may be disposed inside the outer container 10 in a manner of facing the container lid 20, and in this way, the opening of the accommodation space 72 faces the saw-toothed structure 31. In this case, after the container lid 20 is locked in a spinning manner to the bottom, the saw-toothed structure 31 would not penetrate through the three sealing films 42, 43, 44, but is accommodated inside the accommodation space 72. In another aspect, when the user needs oxygen generation, as shown in FIG. 9, the bottom surface 71 is disposed inside the outer container 10 in a manner of facing the bottom surface 15 of the outer container 10, and in this way, the opening of the accommodation space 72 faces the bottom surface 15 of the outer container 10, and an opening 80A of the second inner container 80 faces the piercing member 30. Subsequently, the user locks the container lid 20 in a spinning manner to the bottom to enable the saw-toothed structure 31 to penetrate the three sealing films 43, 44, 42 in sequence, so as to mix the reaction liquid, the reactant, and the catalyst in the first inner container 70 to generate oxygen.

In some implementation manners, as shown in FIG. 8, when the piercing member 30 is accommodated inside the accommodation space 72 and the container lid 20 is locked along the outer screw thread 11 in a spinning manner to the stopping flange 12, the extending foot 21 abuts against the bottom surface 71 of the first inner container 70 to position the first inner container 70, so as to further prevent the saw-toothed structure 31 from being damaged because the user inverts the oxygen generation apparatus to make the saw-toothed structure 31 in contact with a wall surface of the accommodation space 72. In another aspect, as shown in FIG. 9, the extending foot 21 abuts against the connection wall 81 to position the second inner container 80 in the first inner container 70, so as to prevent the second inner container 80 from moving relative to the first inner container 70 because of being subject to an external force.

In conclusion, according to the first embodiment and second embodiment of the oxygen generation apparatus of the present invention, in addition to an advantage of portability with respect to the prior art, an accommodation space is formed between an outer wall and an inner wall of an inner container, and when a chemical reaction is performed on an oxygen generating agent, if the reaction is violent, a great amount of gas is generated, and part of the gas may be temporarily accommodated between the outer wall and the inner wall, which would not cause a problem that a great amount of gas mixed with the oxygen generating agent is sputtered out through a hole. Further, with respect to a product that does not have the foregoing accommodation space, an outer diameter of an opening of an inner container may be designed to be smaller to further reduce an outer diameter of a sealing film, so as to make it easier to scratch the sealing film.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An oxygen generation apparatus, comprising:
an outer container;
a container lid, provided with a hole, wherein the container lid may be locked in a spinning manner to an opening end of the outer container;
a piercing member, wherein a first end of the piercing member is movably combined with the container lid to enable the piercing member to move to a first position and a second position relative the container lid, and a second end of the piercing member has a saw-toothed structure; and
an inner container, disposed inside the outer container and configured to accommodate an oxygen generating agent, wherein an annular flange is formed inside the inner container, an upper surface of the annular flange is provided with a first sealing film, and a lower surface of the annular flange is provided with a second sealing film, wherein:
when the piercing member is located at the first position, the saw-toothed structure is at a distance from the first sealing film, and when the piercing member is located at the second position, the saw-toothed structure penetrates through the first sealing film and the second sealing film.

2. The oxygen generation apparatus according to claim 1, wherein the inner container further comprises an outer wall, an inner wall, and a connection wall, the inner wall defines an opening of the inner container, the outer wall surrounds the inner wall and is connected to the inner wall through the connection wall, the inner wall extends from the opening toward a bottom surface of the outer container, a distance between an end edge of the inner wall and the bottom surface is greater than a distance between an end edge of the outer wall and the bottom surface, the outer wall defines another opening of the inner container, the annular flange is disposed in a convex manner on the inner wall, the end edge of the outer wall is provided with a third sealing film, and when the piercing member is located at the second position, the saw-toothed structure further penetrates through the third sealing film.

3. The oxygen generation apparatus according to claim 2, wherein an inner wall of the outer container is provided in a convex manner with a plurality of bumps, and a surface of each of the bumps stops the outer wall of the inner container, so as to enable the third sealing film and the bottom surface of the outer container to form an accommodation space.

4. The oxygen generation apparatus according to claim 3, wherein the outer wall of the inner container is further provided in a concave manner with at least one positioning recess, which extends along a direction vertical to a circumferential direction of the outer wall, the inner wall of the outer container is further provided in a convex manner with another bump, and the another bump is each embedded into each positioning recess to position the inner container in the outer container.

5. The oxygen generation apparatus according to claim 3, wherein the inner wall of the outer container is further provided in a convex manner with a first stopping block and a second stopping block inside the accommodation space, a vertical distance from the first stopping block to the bottom surface is not equal to a vertical distance from the second stopping block to the bottom surface, the oxygen generation apparatus further comprises a filter screen, and the filter screen is stopped between the first stopping block and the second stopping block.

6. The oxygen generation apparatus according to claim 2, further comprising another inner container, disposed inside the outer container, wherein the another inner container is configured to accommodate the inner container, an inner wall of the another inner container is provided in a convex manner with a plurality of bumps, and a surface of each of the bumps stops the outer wall of the inner container, so as to enable the third sealing film and a bottom surface of the another inner container to form an accommodation space.

7. The oxygen generation apparatus according to claim 6, wherein the outer wall of the inner container is further provided in a concave manner with at least one positioning recess, which extends along a direction vertical to a circumferential direction of the outer wall, the inner wall of the another inner container is further provided in a convex manner with another bump, and the another bump is embedded into each positioning recess to position the inner container in the another inner container.

8. The oxygen generation apparatus according to claim 6, wherein a bottom of the outer container further comprises a plurality of limiting flanges disposed at intervals, an outer surface of the another inner container is provided in a convex manner with a limiting convex column corresponding to the limiting flanges, and the limiting convex column moves between two adjacent limiting flanges.

9. The oxygen generation apparatus according to claim 6, wherein the inner wall of the another inner container is further provided in a convex manner with a first stopping block and a second stopping block inside the accommodation space, a vertical distance from the first stopping block to the bottom surface of the another inner container is not equal to a vertical distance from the second stopping block to the bottom surface of the another inner container, the oxygen generation apparatus further comprises a filter screen, and the filter screen is stopped between the first stopping block and the second stopping block.

10. The oxygen generation apparatus according to claim 3, wherein the piercing member further comprises at least one notch, located at a second end of the piercing member, and when the piercing member is located at the second position, an extending line of the upper surface of the annular flange and an extending line of the at least one surface penetrate through the at least one notch.

11. The oxygen generation apparatus according to claim 10, wherein the container lid comprises an extending foot, connected to a bottom plate of the container lid, the extending foot extends from the bottom plate toward the inner container, and when the container lid is locked in a spinning manner to the bottom, the extending foot abuts against the connection wall to position the inner container.

12. The oxygen generation apparatus according to claim 10, wherein the container lid comprises a bottom plate and a surrounding wall, an end of the surrounding wall is connected to a surface of a side, facing the inner container, of the bottom plate, the surrounding wall surrounds the hole, the piercing member has an opening on the first end, the piercing member is combined with the surrounding wall through the opening in a surrounding manner, so as to be able to move to the first position and the second position relative to the surrounding wall.

13. The oxygen generation apparatus according to claim 12, wherein an outer surface of the surrounding wall comprises a groove, a first bearing rib, and a second bearing rib, the groove comprises a vertical groove section and a horizontal groove section, the vertical groove section extends along a direction vertical to the outer surface of the surrounding wall, the horizontal groove section extends along a circumferential direction of the outer surface of the surrounding wall, the first bearing rib and the second bearing rib are respectively disposed in a convex manner on the vertical groove section and the horizontal groove section, the first end of the piercing member is provided with an elastic plate, a terminal end of the elastic plate is provided in a convex manner with a flange corresponding to the first bearing rib and the second bearing rib, the flange may move in the vertical groove section and the horizontal groove section, the first bearing rib is configured to stop the flange to position the piercing member at the first position, and the second bearing rib is configured to stop the flange to position the piercing member at the second position.

14. The oxygen generation apparatus according to claim 13, wherein the second bearing rib extends along an extending direction of the vertical groove section, the flange is provided in a concave manner with a vertical recess, and the second bearing rib may be clamped inside the vertical recess to stop the flange.

15. An oxygen generation apparatus, comprising:
an outer container;
a container lid, provided with a hole, wherein the container lid may be locked in a spinning manner to an opening end of the outer container;
a piercing member, wherein a first end of the piercing member is connected to the container lid, and a second end of the piercing member has a saw-toothed structure;
a first inner container, configured to accommodate an oxygen generating agent and disposed inside the outer container, wherein the first inner container has an opening and a bottom surface opposite to the opening, and the bottom surface is disposed in a concave manner toward the opening to form an accommodation space;
a second inner container, configured to accommodate another oxygen generating agent and disposed inside the first inner container to seal the opening, wherein an annular flange is formed inside the second inner container, an upper surface of the annular flange is provided with a first sealing film, and a lower surface of the annular flange is provided with a second sealing film, wherein:
when the bottom surface of the first inner container is disposed inside the outer container in a manner of facing the container lid, and the container lid is locked in a spinning manner to the bottom, the piercing member is accommodated inside the accommodation space, and when the bottom surface of the first inner container is disposed in the outer container in a manner of facing the bottom surface of the outer container, and the container lid is locked in a spinning manner to the bottom, the saw-toothed structure penetrates the first sealing film and the second sealing film.

16. The oxygen generation apparatus according to claim 15, wherein the second inner container further comprises an outer wall, an inner wall, and a connection wall, the inner wall defines an opening of the second inner container, the outer wall surrounds the inner wall and is connected to the inner wall through the connection wall, the inner wall extends from the opening of the second inner container toward the bottom surface of the first outer container, a distance between an end edge of the inner wall and the bottom surface is greater than a distance between an end edge of the outer wall and the bottom surface, the outer wall defines another opening of the second inner container, the annular flange is disposed in a convex manner on the inner wall, the end edge of the outer wall is provided with a third sealing film, and when the bottom surface of the first inner container is disposed inside the outer container in a manner of facing the bottom surface of the outer container, and the container lid is locked in a spinning manner to the bottom, the saw-toothed structure further penetrates through the third sealing film.

17. The oxygen generation apparatus according to claim 16, wherein an inner wall of the first inner container is provided in a convex manner with a plurality of bumps, and a surface of each of the bumps stops the outer wall of the second inner container.

18. The oxygen generation apparatus according to claim 17, wherein the outer wall of the second inner container is further provided in a concave manner with at least one positioning recess, which extends along a direction vertical to a circumferential direction of the outer wall, the inner wall of the first inner container is further provided in a convex manner with another bump, and the another bump is embedded into each positioning recess to position the second inner container in the first inner container.

19. The oxygen generation apparatus according to claim 17, wherein the piercing member further comprises at least one notch, located at a second end of the piercing member, and when the bottom surface of the first inner container is disposed inside the outer container in a manner of facing the bottom surface of the outer container, and the container lid is locked in a spinning manner to the bottom, an extending line of the upper surface of the annular flange and an extending line of the at least one surface penetrate through the at least one notch.

20. The oxygen generation apparatus according to claim 19, wherein a bottom of the outer container further comprises a plurality of limiting flanges disposed at intervals, an outer surface of the first inner container is provided in a convex manner with a limiting convex column corresponding to the limiting flanges, and the limiting convex column moves between two adjacent limiting flanges.

21. The oxygen generation apparatus according to claim 20, wherein the container lid comprises an extending foot, connected to a bottom plate of the container lid, the extending foot extends from the bottom plate toward the second inner container, and when the bottom surface of the first inner container is disposed inside the outer container in a manner of facing the bottom surface of the outer container, and the container lid is locked in a spinning manner to the bottom, the extending foot abuts against the connection wall to position the second inner container.

22. The oxygen generation apparatus according to claim 21, wherein when the piercing member is accommodated inside the accommodation space, the extending foot abuts against the bottom surface of the first inner container to position the first inner container.

23. The oxygen generation apparatus according to claim 21, wherein the inner wall of the first inner container is further provided in a convex manner with a first stopping block and a second stopping block between the third sealing film and the bottom surface of the first inner container, a vertical distance from the first stopping block to the bottom surface is not equal to a vertical distance from the second stopping block to the bottom surface, the oxygen generation apparatus further comprises a filter screen, and the filter screen is stopped between the first stopping block and the second stopping block.
